(19) United States
(12) Patent Application Publication
(10) Pub. No.: US 2013/0166406 A1
(43) Pub. Date: Jun. 27, 2013

(54) SYSTEM AND METHOD FOR GENERATING USER RECOMMENDATIONS

(71) Applicant: BARNESANDNOBLE.COM LLC, New York, NY (US)

(72) Inventors: Emily S. D. Yardley, Fredericksburg, TX (US); Yufan Hu, North Brunswick, NJ (US); James Mustich, New Fairfield, CT (US); Jonathan Huizhong HUANG, Cupertino, CA (US)

(73) Assignee: BARNESANDNOBLE.COM LLC, New York, NY (US)

(21) Appl. No.: 13/722,784

(22) Filed: Dec. 20, 2012

Related U.S. Application Data
(60) Provisional application No. 61/580,090, filed on Dec. 23, 2011.

(51) Int. Cl. G06Q 30/06

(52) U.S. Cl. CPC G06Q 30/0631
USPC 705/26.7

(57) ABSTRACT

The present invention creates a new taxonomy called Reader Categories that incorporates a bookseller's bookselling knowledge to generate more accurate and compelling recommendations to users. An initial “seeding” of the Reader Categories with content is performed by an editorial staff. A recommendation engine is then executed with respect to the initial seeds to generate recommendation of additional content for the Categories. A tool is provided that the editorial staff can use for the seeding and for providing feedback on the quality of algorithmically generated results. This helps the present invention extend the power of its recommendation algorithms by facilitating editorial ranking and seeding.

### FIELD OF THE INVENTION

The present invention generally relates to systems and methods for generating recommendations of products or services to users.

### BACKGROUND OF THE INVENTION

In recent years, the accessibility to and provision of information and content such as movies, music and books, etc. have increased explosively. The advent of the Internet as an increasingly available source of information has resulted in the main problem that faces most users, namely not whether appropriate information or content is available but how this can be found. Specifically, it has become increasingly important that the services and content provided to a user are targeted to this user and thus meet his specific user profile and reflect his personal preferences.

One method of customizing e.g. the information and content provision to a specific user is a recommendation-based approach. In accordance with this approach, specific content or information is determined to be particularly suited for a particular user and therefore recommended to her. One recommendation approach is a community-based recommendation approach, wherein feedback and preferences received from a suitable community are used to determine recommendations for a user in that community. An example of a community-based recommendation system is known from several e-commerce Internet sites, wherein the purchasing behavior of users is monitored. A user having a purchasing behavior similar to a stored behavior is recommended purchases similar or identical to purchases made by other users in that group. A well-known example is when a purchaser of a book is recommended a number of other books that have been purchased by other users also purchasing the current book.

Typically, community-based recommendation systems operate by comparing user profiles of different users and recommending users content that other users having similar profiles have preferred. However, typically, users will therefore only or predominantly be recommended content that has already been evaluated by other users. Typically, for community-based recommendation systems, the recommendations made tend to be of content with the highest prevalence in user profiles. Therefore, the more user profiles comprise a given content, the more likely it is to be recommended to another user. The more a content item is recommended, the more likely it is to be included in a user profile, and as the probability of a content item being recommended increases with increased dissemination, a community-based recommendation system typically has a tendency towards providing undesirably narrow recommendations of mainly the most popular content items. The recommendations may further become increasingly narrow over time and thus do not provide a desired flexibility and diversity in the recommendations. Specifically, it tends to be difficult for a new content item to be introduced to a community-based recommendation system without an undesirable latency.

### SUMMARY OF THE INVENTION

Systems that generate recommendations for products or services to users necessarily operate on data contained in the system. Traditionally, this data is related to the product or service itself or to users' habits with respect to the product or service. For example, in regard to the users' habits, some systems generate recommendations based on users' buying habits such as ‘People who bought this product, also bought that product.’ in regard to the product or service itself, some systems make recommendations such as ‘Here are some other services offered by this provider’ or ‘Here are some other services related to this service.’

Although in the preferred embodiment of the present invention described herein, the product is books, those skilled in the art will recognize that the systems and methods of the present invention are equally applicable to other products or services such as music, movies, magazines, games, software, electronics or clothing. The following description is made with respect to book content, but is equally applicable to other forms of content and other products and services.

Booksellers receive unstructured metadata from hundreds (if not thousands) of book publishers. These publishers typically use their own subject and genre taxonomies to classify the content of a book. These taxonomy nodes are difficult to normalize, leaving booksellers with several definitions of a single node and multiple nodes with the same definition. For example, there may be multiple nodes for “Italian Cooking” and several nodes for Cooking called “Cooking—miscellaneous,” “General Cooking,” and simply “Cooking.” The result of this taxonomy is a less than optimal browsing experience for users when they are shopping by subject or genre, or when recommendations are being made.

People looking for their next book to read often do not shop by subject or genre. They are looking for a book that will provide a certain reading experience to them, or a book similar to another book that they have read and loved.

The present invention recognizes these above problems with the current taxonomy and recommendation systems and leverages a bookseller's bookselling expertise and inventory management data to provide solutions. One aspect of the present invention is a new taxonomy called Reader Categories that incorporates a bookseller's bookselling knowledge to generate more accurate and compelling recommendations to users. The Reader Categories provide a way for readers to shop/browse for new books to read based on the reading experience they enjoy most and to allow the system to generate recommendations that are more accurately aligned with readers' interests. The Reader Categories provide a scalable mechanism to classify books into a new taxonomy based on themes that cross common subject and genre classification systems.

No other system provides a mechanism for users to discover books comparable to the present Reader Categories. Typical browsing is done through subject and genre. The present Reader Categories are created by leveraging a bookseller's many years of bookselling intelligence and then using the present invention's recommendation algorithms to cover hundreds of related items in the bookseller's catalog.

In an initial embodiment, the user is presented with a basic taxonomy of a certain number of Reader Categories from which he can choose the ones in which he is interested. Based on an analysis of the customers' book preferences, purchases and views of content, the system gathers further data to make Reader Category suggestions.

The present invention further involves a suite of tools that deliver basic and personalized recommendations. As described above, the present invention is able to considerably improve the quality of these recommendations by incorporating input from bookseller personnel and data from its inventory management system, which contains a wealth of location-based bookselling knowledge.

An important aspect of the present invention is the initial “seeding” of the Reader Categories with content. This seeding is accomplished by incorporating the suggestions of the knowledgeable personnel in the bookseller's organization, e.g., buyers or editors. The present invention includes tools that the personnel can use for the seeding and for providing feedback on the quality of algorithmically generated results. This helps the present invention extend the power of its recommendation algorithms by facilitating editorial ranking and seeding.

The editorial rankings are used to help improve the order in which recommendations are presented. If strong recommendations appear further down in a list, editorial ranking can help boost them to a higher position, indicating to the recommendation algorithm that these recommendations should have a greater strength.

Editorial seeding is used to inform the recommendation algorithm about items that should be included in a set of recommendations. The algorithms can use the seeded recommendation set to create new recommendations. This is one manner in which Reader Categories are created.

The present invention further includes a recommendation engine that is driven from the data captured in the Reader Categories.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates an exemplary user interface used for seeding the Reader Categories;

FIG. 2 illustrates a process of combining Bookselling Intelligence with Search Intelligence to create Reader Categories;

FIG. 3 depicts a process for populating the titles in a Reader Category;

FIG. 4 illustrates a editor user interface with two expanded levels of system generated potential seeds;

FIG. 5 illustrates an exemplary user interface for users to access and explore the recommendations made in Reader Categories;

FIG. 6 illustrates a grid view of a Reader Category;

FIGS. 7 and 8 depict Related Authors, Series, and Subjects tools;

FIG. 9 illustrates a Merchant Input tool;

FIG. 10 depict a tool for personalizing a user's profile; and

FIG. 11 illustrates an exemplary system according to the present invention.

### DETAILED DESCRIPTION OF THE INVENTION

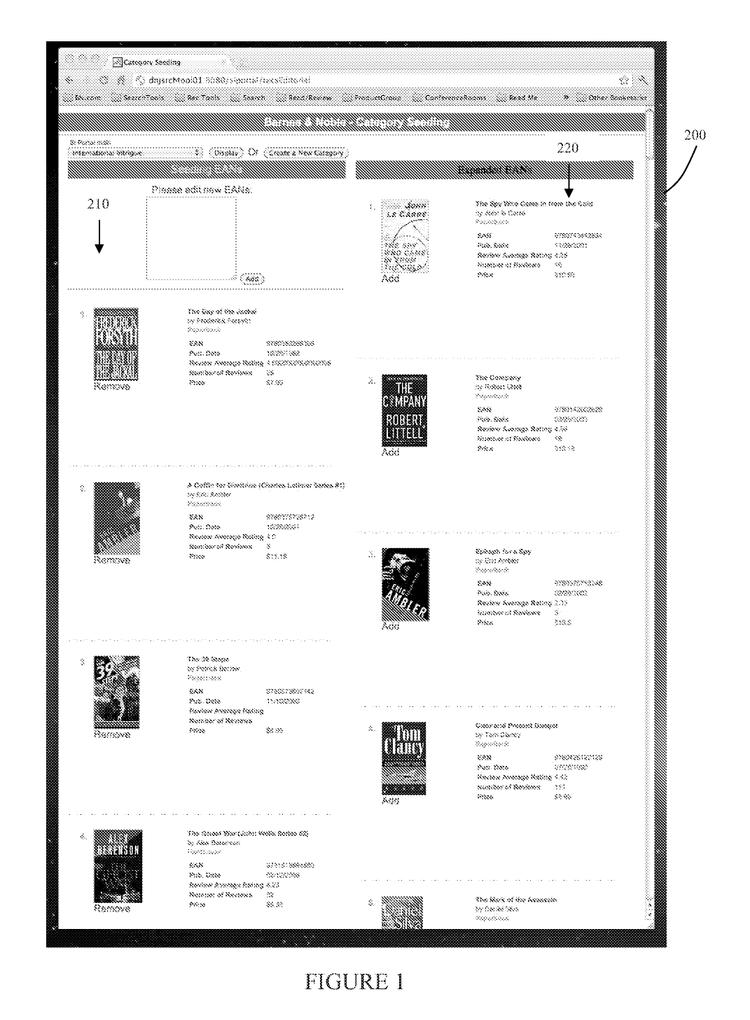

FIG. 1 illustrates an exemplary user interface 200 used for seeding the Reader Categories. Creating a new Reader Category begins with an idea from an editor at a bookseller about what the category should be. Note the description contained herein uses the term ‘editor’ to denote any personnel at the bookseller involved in the seeding and editing process. This can include editors, buyers, or retail location personnel.

In the example illustrated in FIG. 1, the Reader Category being created is

‘International Intrigue.’ Once the category has been created, the various editors at the bookseller use the Category Seeding tool to seed it with books that epitomize this category. In one embodiment, each editor selects eight to ten titles that she believes properly reflect the category.

As an editor adds each new book to the category seed, it appears on the left side 210 of the tool interface 200. As the editor is adding her choices for seeds to the category, the system presents additional titles on the right side 220 of the interface 200. The books on the right 220 are algorithmically generated by the system based on the titles that the editor has included in her seeding 210. The algorithms for the system generated recommendations for additional seeds can be traditional algorithms, such as ‘Customers who bought this title, also bought this title.’ One aspect of the system generated recommendation is the correlation between the editor selected seed title and the title being recommended. As described herein, the correlation can be established several ways, sonic relating to the product itself, e.g., other books by this author, and some relating to consumers behavior with respect to the product, e.g., consumers' that viewed this product, eventually bought this product.

As new books are populated on the right 220, the editor can indicate that these new items should also be added to her seeding 210. The editor can also indicate that these new items recommended by the system are not related to this category and should therefore he removed. By this mechanism, the system of the present invention leverages the knowledge and experience of the bookseller's personnel to create a highly useful and accurate database in each Reader Category.

Once a new Reader Category is seeded with, for example, ten titles, the system can algorithmically generate 75-100 additional recommendations that are related to the original seeding. Again, as described herein, the correlation between the seeded title and the system generated recommendation can be established several ways, some relating to the product itself, and some relating to consumers behavior with respect to the product. One algorithm that can be used for this expansion is a multi-EAN co-purchase algorithm that finds items strongly related to the entire seeding. As described above, these algorithms can be based on common correlation algorithms but can be adjusted for the specific purposes of further populating the Reader Categories. For example, the algorithms can be adjusted to combine the seeding of any number of different editors. Significantly, the recommendations generated for a Reader Category are weighted and ranked based on their relationship to the set of items in the seed.

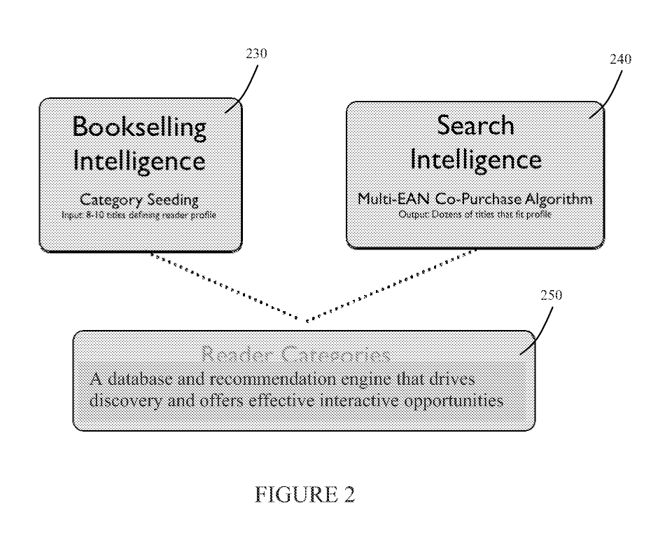

FIG. 2 illustrates the process described above of combining Bookselling Intelligence 230 with Search Intelligence 240. The users of the system and method of the present invention use their combined years of bookselling experience to create the initial seeds in the Reader Categories 250. The Search Intelligence 240 is typically embodied in a recommendation engine containing sophisticated algorithms. The Search Intelligence 240 can either be a traditional recommendation engine or one that is modified to specifically work with the Reader Categories 250 of the present invention. The Search Intelligence 240 is executed to generate recommended content that can be used fill out the Reader Categories 250 with titles that algorithmically fit into Reader Categories 250. As described above, it is an iterative process in which the human editors can review the titles suggested by the Search Intelligence 240 and accept or reject the suggestions as being appropriate or inappropriate for the particular Reader Category. The results of this process are items contained in Reader Categories 250 and ultimately the recommendations that flow therefrom using a recommendation engine.

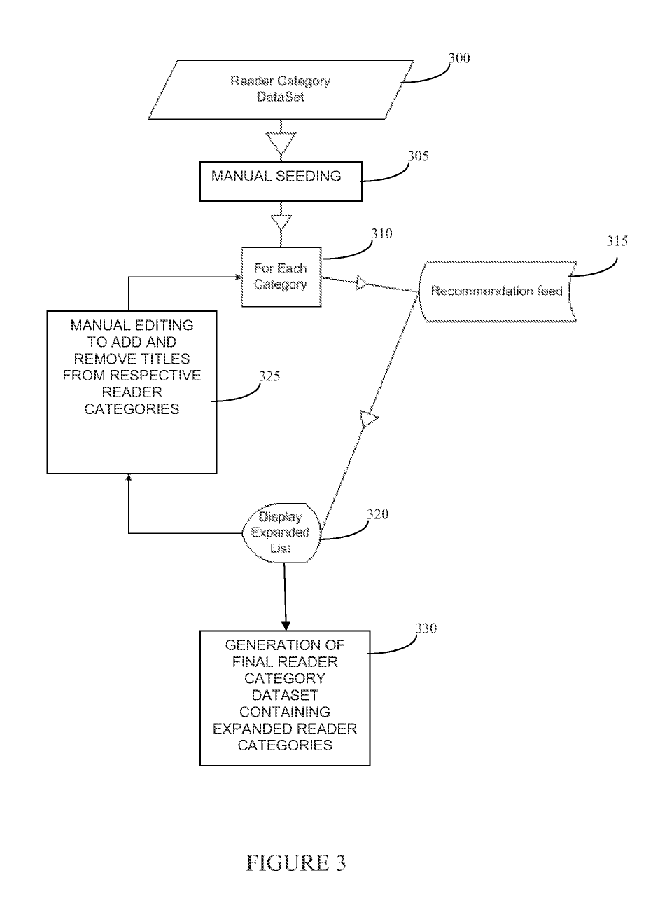

FIG. 3 depicts in more detail the process for seeding and populating the titles in a Reader Category. In step 300 the editorial staff establishes one or more Reader Categories in a database in the system. In step 305, the editorial staff manually seeds the one or more Reader Categories with an initial seeding of preferably eight to ten titles that are exemplary of the respective Reader Categories. Step 310 begins an iterative process for each of the Reader Categories. In step 315, the Search Intelligence 240 (FIG. 2) analyzes the titles in the Reader Categories and generates further recommendations for the Reader Categories in the form of additional titles. In act 320, the recommended titles are displayed to the editorial staff. In act 325, the editorial staff reviews the titles recommended by the Search Intelligence 240 (FIG. 2) and either rejects them or adds them to the respective Reader Category. This process 310-325 is iteratively repeated. Although the process can be repeated indefinitely, the editorial staff can exit it at any point, or the process can automatically (programmatically) end when there are a predetermined number of titles in the Reader Category. This process is repeated for each Reader Category. At the end of the process, the system and method has generated 330 a database containing fully populated Reader Categories. As described above, the Reader Categories can then be used for browsing by the users of the system and generating recommendations to users.

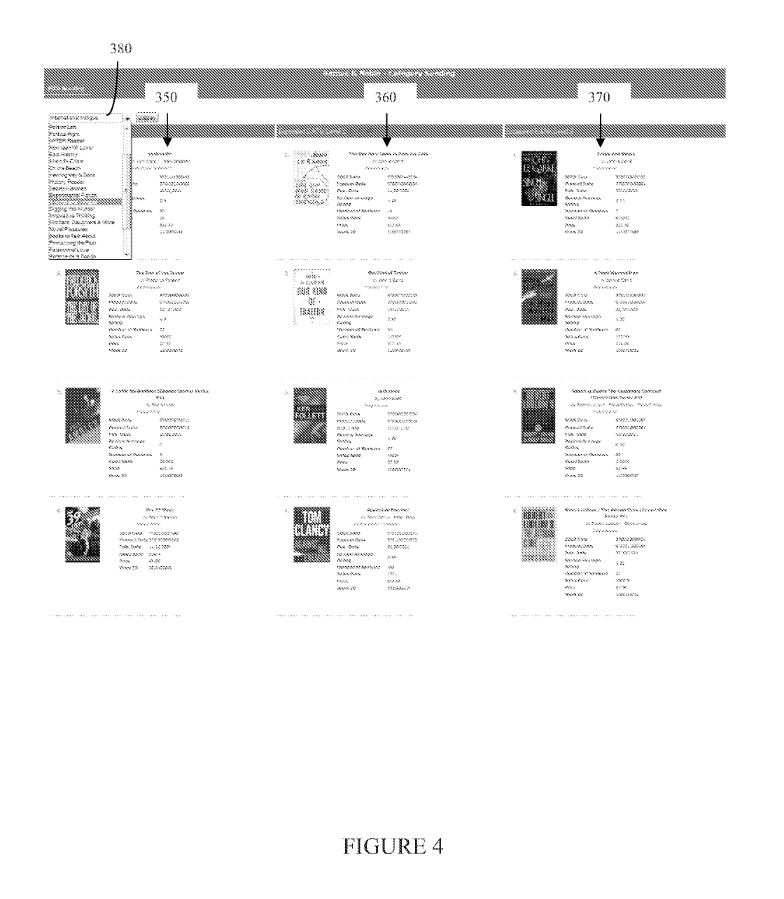

FIG. 4 illustrates a user interface that can be used by the editorial staff users to view the current seeding 350 of a Reader Category and two levels 360, 370 of system generated recommendations for seeds. To use this interface, an editorial staff member can select a specific Reader Category from dropdown menu 480. There is a selectable item in drop down menu representing each Reader Category. After the user selects a Reader Category she want to view, similar to the illustration in FIG. 1, column 350 displays to the user the titles in the database that compromise the initial seeds for the selected Reader Category selected by the editorial staff. Column 360 contains titles generated by the search intelligence (240, FIG. 2) as recommendations to the selected Reader Category that were added to the selected Reader Category by the processes shown in the FIGS. 2 and 3. Column 370 represents an expanded level of recommendations from the search intelligence (240, FIG. 2) for additional titles that can be added to the Reader Category. In a preferred embodiment, this expanded level of recommendations contains titles that are related to the selected Reader Category, but perhaps not as closely related as the titles contained in the first level 360 of system generated potential titles. For example, if the selected Reader Category is International Intrigue and one of the authors in the first level 360 is John Le Cane, the second level of expanded recommendations 370 might include other books by John Le Carre that don't necessarily deal with International Intrigue. In a preferred embodiment, the metadata for the titles (content) contained in column 370 contain data indicating that these titles are related to the selected Reader Category. This data assists the editorial staff and the search intelligence (240, FIG. 2) in other recommendations in the system.

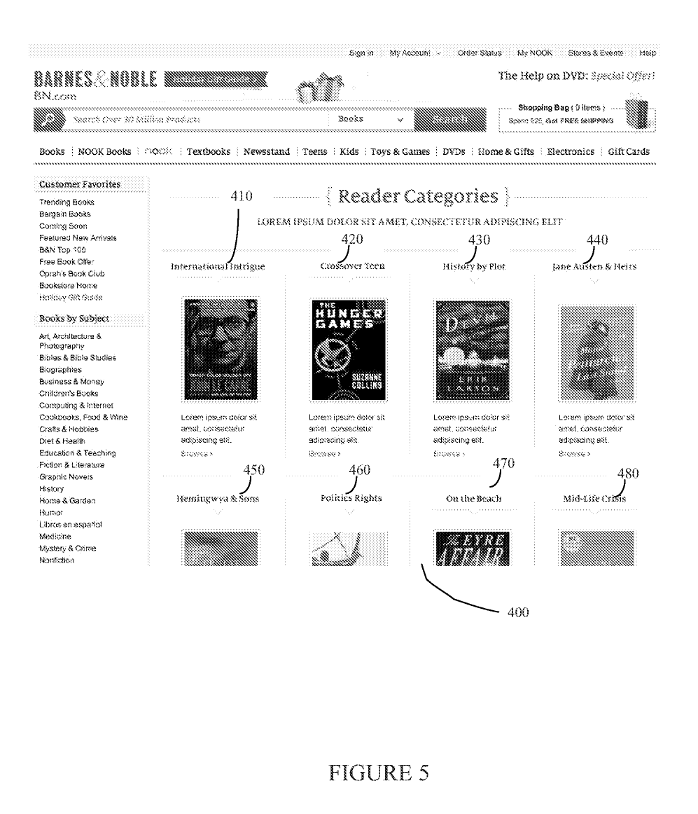

FIG. 5 illustrates a user interface 400 that allows users to access and explore the recommendations made in Reader Categories. The user interface 400 is designed for customers of the goods and services contained in the Categories. The interface 400 is very simple, and allows users to browse the full set of categories and choose which ones they would like to explore further. FIG. 5 illustrates the preferred embodiment of the present invention in which the goods are books. As illustrated in the this example user interface 400, the Reader Categories shown in FIG. 5 include International Intrigue 410, Crossover Teen 420, History by Plot 430 Jane Austen & Heirs 440, Hemingway & Sons 450, Politics Rights 460, On the beach 470 and Mid-Life Crisis 480.

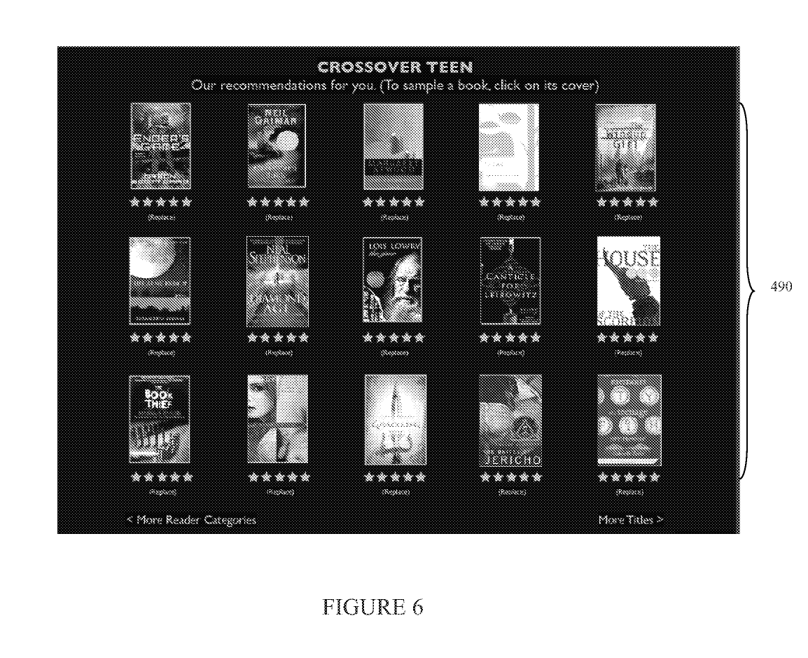

Clicking on a particular Reader Category will take the user to a grid view of search results showing the selection of books in that category. For example, if the user selects the Crossover Teen category 420, the system presents the user with a user interface containing a matrix of the books in that category 490, as illustrated in FIG. 6. The user can click on any of the icons representing the books in matrix 490 and be brought to a more full description of that book, and also be given the opportunity to purchase that book. The user can further scroll the matrix 490 to view all of the books contained in the category.

The system and method of the present invention provides the editorial staff with tools that allow them to view the various recommendations made by system. Specifically, the Best Selling Authors, Series, and Subjects tools allow editors to review a list of bestselling authors, series, and subjects.

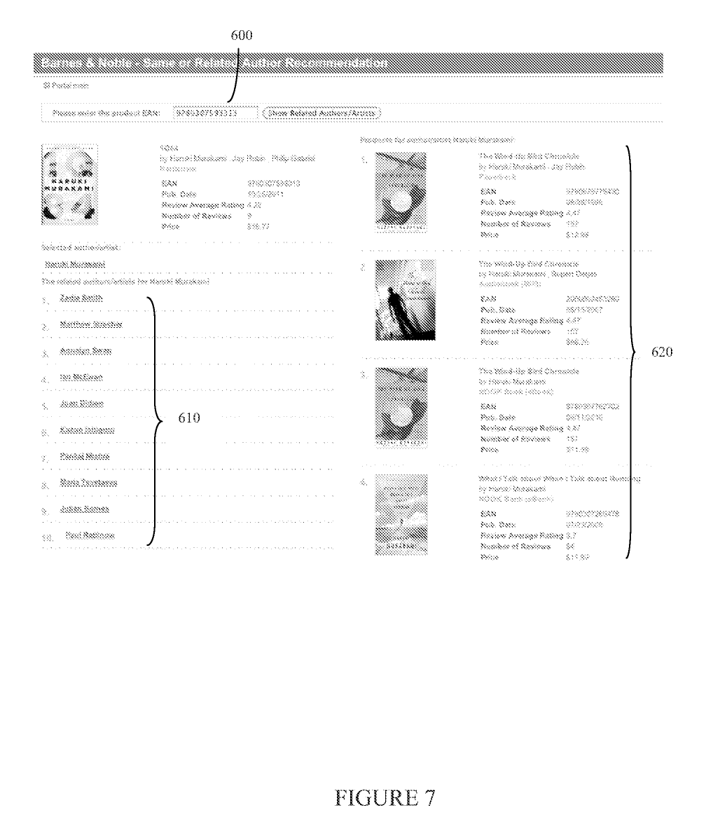

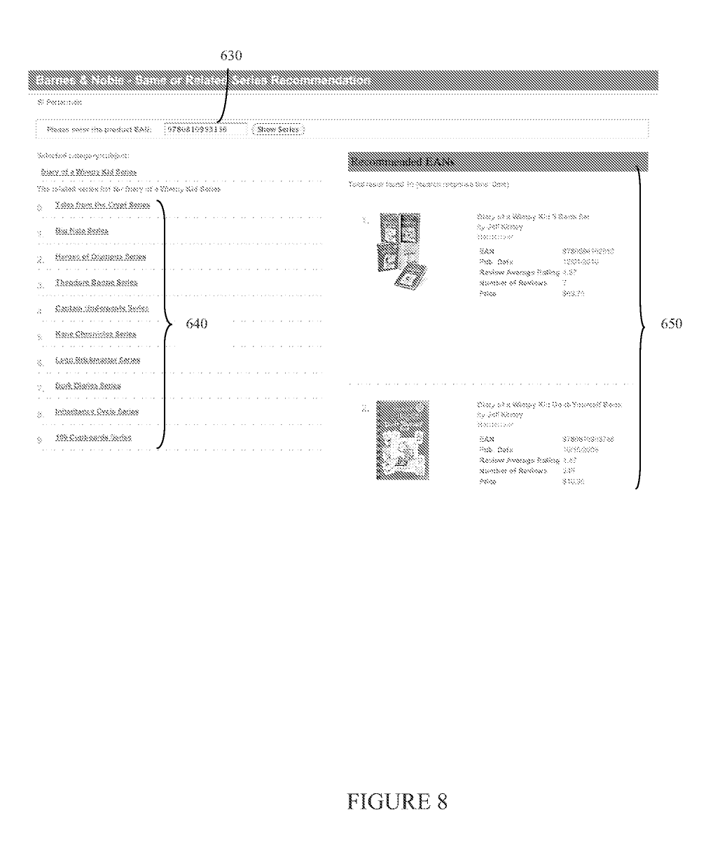

FIGS. 7 and 8 depict Related Authors, Series, and Subjects tools that allow editors to review related author, series and subject recommendations made by the system for a specific EAN. In the user interface illustrated in FIG. 7, the editor inputs the EAN for book written by the author in interest in input box 600. The system then executes its recommendation engine and displays the list 610 of authors/artists that are deemed similar to or related to the author of the specified FLAN. At the same time, the system also lists the other titles 620 by the same author that are in the system.

Similarly, as shown in FIG. 8, the editor can input an EAN of a series into input box 630, and the system will show the editor a list 640 of series that the recommendation engine determines are similar to or related to the series identified by the specified EAN. At the same time, the system also shows a list 650 of the all of the titles in the specified series.

The system of the present invention also includes several other tools that allow the editorial staff to continually improve and upgrade the recommendation system. A Bundle Suggestion tool allows editors to review system suggested product bundles for a specific EAN and price point. These bundles and price points can be modified using this tool. A Co-Viewed tool allows editors to review system generated co-viewed recommendations for a specific or random EAN. A View-to-Purchase tool allows editors to review View-to-purchase recommendations, i.e. “Customers who viewed this book ultimately bought this book” recommendations for a specific or random EAN. A Related Searches tool allows editors to review related search recommendations for a specific or random search query. A Basic Hero Product tool allows editors to review the order of specific versions/formats of a particular title (or work) that are presented to the user. An A/B Comparison tool allows editors to review the differences between two versions of the same recommendation algorithm.

As described above, the Reader Categories tool allows editors to create new Reader Categories, seed them with a set of quintessential EANs, and review additional, algorithmically generated suggestions for that category.

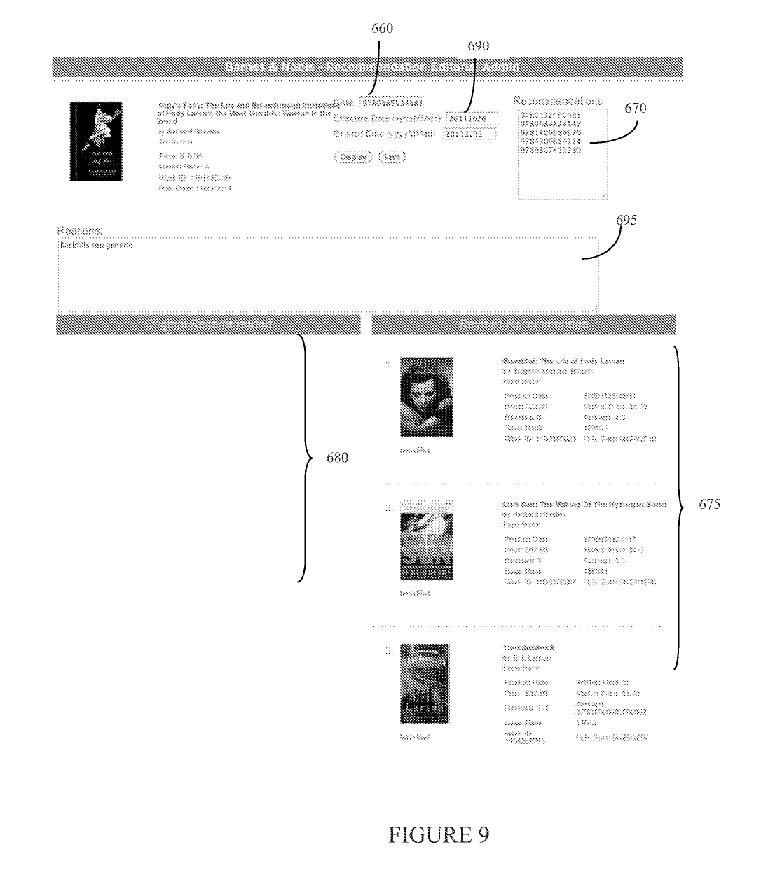

A Merchant Input tool as illustrated in FIG. 9 allows editors to insert new items into the list of algorithmically generated co-purchase recommendations for a specific EAN, or change the order of existing items already in the list. To employ this tool, the user inputs the specific EAN into input box 660. The recommendations generated by the system are listed in area 680. In this particular example, no recommendations have been made by the system. The editor can then manually input or delete recommendations in area 670. The full listing of the EANs recommended is displayed in area 675. These changes can be qualified with a date range in input boxes 690 so that time based promotions automatically revert to the algorithmically generated state. The editor can further input a textual description in box 695 describing the reasons for the manual changes to the recommendations.

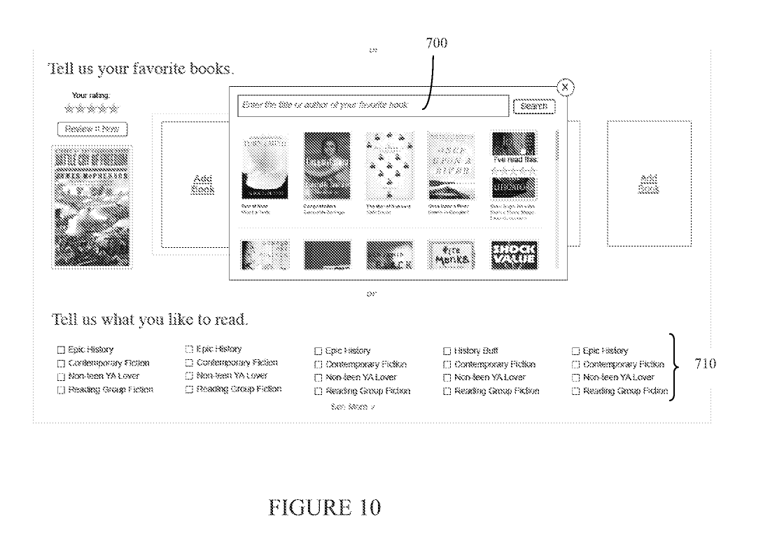

The present invention further includes a personalized user interface on the bookseller's website. The website offers the opportunity for an interactive, reader-defined discovery experience by suggesting Reader Categories to users based on their favorite books. As illustrated in FIG. 10, the reader/user can customize her profile by inputting in input box 700 her favorite book. The user can additionally, though checking check boxes in area 710, select the Reader Categories that most interest her. Using this personal preference data input by the user, the system can further customize the recommendations made by the recommendation engine. Users are easily able to opt into and out of the suggestions and further refine them by providing the bookseller with their preferences. The end state is a discover ecosystem built around books and readers' profiles.

The system of the present invention further generates personalized mails to users. These emails are sent to users when new books are released by their favorite authors, in their favorite series, or in their favorite Reader Categories.

There is no technical limit to the number of Reader Categories that can be created. Increasing the number and range of Reader Categories creates a highly articulated, proprietary taxonomy defined by booksellers and readers.

The system of the present invention is able to capture and incorporate implicit user feedback in the database. The system tracks the users' clicks within recommendation modules on specific recommendations to inform the strength of each recommendation. The system also uses the same method to test if new books belong as recommendations in particular circumstances.

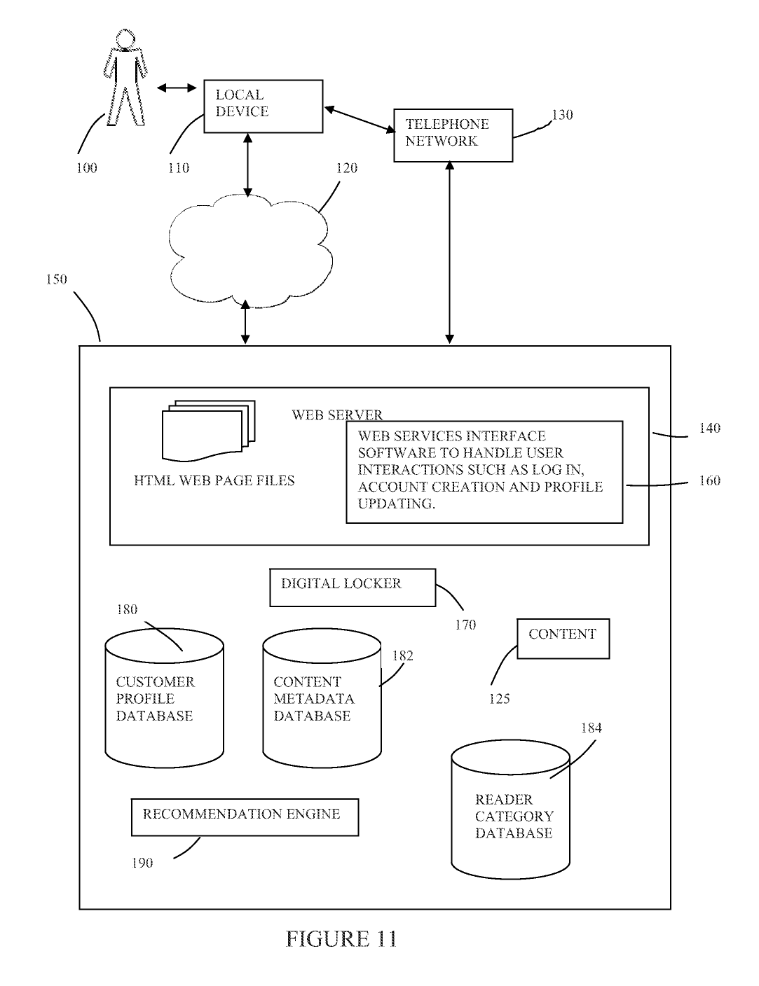

FIG. 11 shows components of a system according to the present invention. User 100 is a user of the system and uses her local device 110 for the reading of digital content and interacting with the system server 150. Many of the functions of the system of the present invention are carried out on server 150. As appreciated by those skilled in the art, many of the functions described herein can be divided between the server 150 and the user's local device 110. Further, as also appreciated by those skilled in the art, server 150 can be considered a “cloud” with respect to the user and his local device 110. The cloud 150 can actually be comprised of several servers performing interconnected and distributed functions. For the sake of simplicity in the present discussion, only a single server 150 will be described. The user 100 can connect to the server 150 via the Internet 120, a telephone network 130 (e.g., wirelessly through a cellphone network) or other suitable electronic communication means. In certain embodiments, user 100 has an account on server 150.

Server 150 handles front-end functions related to web server operations and user interactions with the interfaces in connection with the user's local device 110. Server 150 also handles all backend functions such as those related to managing accounts, tracking user interactions, maintaining digital locker records, maintaining content metadata and Reader Category data.

Server 150 employs web server 140 including web services interface software 160 to handle interactions between front-end component, such as device interfaces and back-end database components of the system. Web server 140 services include serving up the web pages that comprise the web. Web services interface software 160 includes handling users' logins to their accounts.

Back-end database components of the system include customer profile database 180, digital lockers 170, Reader Category database 184 and content metadata database 182. Records for users' accounts and the users' profiles, e.g., preferred Reader Categories, are stored and managed in customer profile database 180. Records for the Reader Categories, e.g., titles included in each category, are stored and managed in Reader Category database 184. Content metadata database 182 serves as a source of metadata and recommendation, use, ranking and other information for individual digital content items 125 in the system.

Web services interface software 160 in the web server 140 updates Customer Profile database 180, digital lockers 170, Reader Category database 184 and content metadata database 182. Editors can also use the web services interface software to perform their seeding and other editorial functions as described above,

Recommendation Engine 190 uses the data in Customer profile database 180, Reader Category database 184 and content metadata database 182 to generate the recommendations as described above,

Associated with the user's account is the user's digital locker 170 located on the server 150. As further described below, in the preferred embodiment of the present invention, digital locker 170 contains links to copies of digital content 125 previously purchased for otherwise legally acquired) by user 100.

Indicia of rights to all copies of digital content 125 owned by user 100, including digital content 125, is stored by reference in digital locker 170. Digital locker 170 is a remote online repository that is uniquely associated with the user's account. As appreciated by those skilled in the art, the actual copies of the digital content 125 are not necessarily stored in the user's locker 170, but rather the locker 170 stores an indication of the rights of the user to the particular content 125 and a link or other reference to the actual digital content 125. Typically, the actual copy of the digital content 125 is stored in another mass storage (not shown). The digital lockers 170 of all of the users who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the lending server 150 can contain millions of files 125 containing digital content.

It is also contemplated that the server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

User 100 can access server 150 using a local device 110. Local device 110 is an electronic device such as a personal computer, an e-book reader, a tablet, a smart phone or other electronic device that the user 100 can use to access the server 150. In a preferred embodiment, the local device has been previously associated or registered, with the user's account using user's account credentials. Local device 110 provides the capability for user 100 to browse content 125 stored on the system, and also download the user's copy of digital content 125 via his or her digital locker 170. After digital content 125 is downloaded to local device 110, user 100 can engage with the downloaded content locally, e.g., read the book, listen to the music or watch the video.

In a preferred embodiment, local device 110 includes a non-browser based device interface that allows user 100 to interact with server 150 in a non-browser environment. Through the device interface, the user 100 is automatically connected to the server 150 in a non-browser based environment. This connection to the server 150 is a secure interface and can be through the telephone network 130, typically a cellular network for mobile devices. If user 100 is accessing server 150 using the Internet 120, local device 110 also includes a web account interface. Web account interface provides user 100 with browser-based access to the server 150 over the Internet 120.

User 100 does not have to be a registered user of the system and can browse the Reader Categories, but will not receive personalized recommendations.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for generating content recommendations to users operable on a computer system having a database, the method comprising:
(a) establishing categories of content in the database, each category to contain an identification of content that is related;
(b) receiving an identification of initial seeds of content in each of the categories through a user interface of the computer system;
(c) the computer system executing a recommendation engine with respect to the content in each category, the recommendation engine generating recommendations of content for additions to the categories, the content being recommended being denoted as recommended content;
(d) receiving input through the user interface as to whether recommended content should be added to the categories;
(e) the computer system adding recommended content to the categories if approved;
(f) the computer system repeating acts (c)-(e) at least once; and
(g) the computer system generating content recommendations for users from the categories.

2. The method of claim 1, wherein the content is represented by information describing the content.

3. The method of claim 2, further comprising:
displaying the information describing the content contained in a particular category a display screen of the computer system; and
simultaneously displaying the information describing the recommended content for the particular category on the display screen of the computer system.

4. The method of claim 3, wherein the act of displaying the information describing the recommended content further comprises:
displaying a first level of recommended content on the display screen; and
simultaneously displaying a second level of recommended content on the display screen, wherein the first level of content is more closely related to the content contained in a particular category.

5. The method of claim 2, wherein content are books, the recommendation engine contains a content metadata database and the content metadata database contains information linking various books, the method further comprising:
receiving a selection of a particular book through the user interface of the computer system, the particular book having an author;
further executing the recommendation engine to identify other authors related to the author of the particular book; and
displaying the identified other authors on the display screen.

6. The method of claim 5, wherein the particular book is part of a series, the method further comprising:
further executing the recommendation engine to identify other series related to the series of the particular book; and
displaying the identified other series on the display screen.

7. The method of claim 2, further comprising:
receiving a selection of a category through the user interface of the computer system;
displaying the content of the selected category on the display screen;
receiving identifications of additions and deletions of content to the selected category through the user interface of the computer system; and
adding and deleting content in the selected category in accordance with the received identifications of additions and deletions.

8. A system for generating content recommendations to users, the system comprising:
a display screen;
a content database that contains items of electronic content;
a content metadata database, the content metadata database containing information describing respective items of the electronic content in the content database;
a memory that includes and instructions for operating the system; and
control circuitry coupled to the memory, coupled to the content database, coupled to the content metadata database and coupled to the display screen, the control circuitry capable of executing the instructions and is operable to at least:
(a) establish categories of content in a category database, each category to contain an identification of content that is related;
(b) receive an identification of initial seeds of content in each of the categories through a user interface on the display screen;
(c) execute a recommendation engine with respect to the content in each category, the recommendation engine generating recommendations of content for additions to the categories, the content being recommended being denoted as recommended content;
(d) receive input through the user interface approving whether recommended content should be added to the categories;
(e) add recommended content to the categories if approved;
(f) repeat acts (c)-(e) at least once; and
(g) generate content recommendations for users from the categories.

9. The system of claim 8, wherein the control circuitry executing the instructions is further operable to at least:
display the information describing the content contained in a particular category on the display screen; and
simultaneously display the information describing the recommended content for the particular category on the display screen.

10. The system of claim 9, wherein the control circuitry executing the instructions is further operable to at least:
display a first level of recommended content on the display screen; and
simultaneously display a second level of recommended content on the display screen, wherein the first level of content is more closely related to the content contained in a particular category.

11. The system of claim 8, wherein items of content are books and wherein the content metadata database contains information linking various books, the control circuitry executing the instructions is further operable to at least:
receive a selection of a particular book through the user, the book having an author;
further execute the recommendation engine to identify other authors related to the author of the particular book; and
display the identified other authors on the display screen,

12. The system of claim 11, wherein the particular book is part of a series, wherein the control circuitry executing the instructions is further operable to at least:
further execute the recommendation engine to identify other series related to the series of the particular book; and
display the identified other series on the display screen.

13. The system of claim 8, wherein the control circuitry executing the instructions is further operable to at least:
receive a selection of a category through the user interface;
display the information describing the respective items of content of the selected category on the display screen;
receive identifications of additions and deletions of content to the selected category through the user interface; and
adding and deleting content in the selected category in accordance with the received identifications of additions and deletions.

14. A non-transitory computer-readable medium comprising a plurality of instructions that, when executed by a computer system, at least cause the computer system to:
(a) establish categories of content in a category database, each category to contain an identification of content that is related;
(b) receive an identification of initial seeds of content in each of the categories through a user interface on a display screen of the computer system;
(c) execute a recommendation engine with respect to the content in each category, the recommendation engine generating recommendations of content for additions to the categories, the content being recommended being denoted as recommended content;
(d) receive input through the user interface approving whether recommended content should be added to the categories;
(e) add recommended content to the categories if approved;
(f) repeat acts (c)-(e) at least once; and
(g) generate content recommendations for users from the categories.

15. The non-transitory computer-readable medium of claim 14, wherein the computer system includes a content database that contains items of electronic content and a content metadata database containing information describing respective items of the electronic content in the content database, wherein the instructions further cause the computer system to:
display the information describing the content contained in a particular category on the display screen; and
simultaneously display the information describing the recommended content for the particular category on the display screen.

16. The non-transitory computer-readable medium of claim 15, wherein the instructions further cause the computer system to:
display a first level of recommended content on the display screen; and
simultaneously display a second level of recommended content on the display screen, wherein the first level of content is more closely related to the content contained in a particular category.

17. The non-transitory computer-readable medium of claim 14, wherein the computer system includes a content database that contains electronic books and a content metadata database containing information describing respective electronic books and information linking various electronic books, wherein the instructions further cause the computer system to:
receive a selection of a particular book through the user interface, the hook having an author;
further execute the recommendation engine to identify other authors related to the author of the particular book; and
display the identified other authors on the display screen.

18. The non-transitory computer-readable medium of claim 17, wherein the particular book is part of a series, wherein the instructions further cause the computer system to:
further execute the recommendation engine to identify other series related to the series of the particular book; and
display the identified other series on the display screen.

19. The non-transitory computer-readable medium of claim 14, wherein the instructions further cause the computer system to:
receive a selection of a category through the user interface;
display information describing the respective items of content of the selected category on the display screen;
receive identifications of additions and deletions of content to the selected category through the user interface; and
adding and deleting content in the selected category in accordance with the received identifications of additions and deletions.
